(19) United States
(12) Patent Application Publication
(10) Pub. No.: US 2026/0220694 A1
(43) Pub. Date: Jul. 30, 2026

(54) MUSIC GENERATION FOR ITEM LISTINGS

(71) Applicant: eBay Inc., San Jose, CA (US)

(72) Inventor: Shrivatsan Navalpakkam Rajagopalan, San Jose, CA (US)

(73) Assignee: eBay Inc., San Jose, CA (US)

(21) Appl. No.: 19/041,458

(22) Filed: Jan. 30, 2025

(51) Int. Cl. G06Q 30/0601; G10H 1/00

(52) U.S. Cl. CPC G06Q 30/0641; G10H 1/0025

(57) ABSTRACT

Music generation for item listings for an online marketplace is described. A user (e.g., seller) may list an item for sale on an online marketplace. The item listing may include information about the item, including a title, a description, and one or more images, among other information. The information may be input into a large language model (LLM), which may be trained on a set of music data and a set of inventory categories of the online marketplace. The LLM may execute to generate a music sample that corresponds to the item. The music sample may be applied to the item listing standalone, or as background music for a video corresponding to the item and included in the item listing.

### BACKGROUND

Online marketplaces support and thus experience numerous and varied activities that facilitate transactions on the online marketplace. Some such activities may include a user (e.g., seller) posting a listing of an item or product for sale. An item listing may include one or more images of the item for sale and in some cases, a video of the item. For example, the video may be generated based on combining the images of the item together with a slide show effect. Often, such videos do not include any audio, including music, and thus, may fail to engage users (e.g., buyers) or influence their purchasing decisions.

### SUMMARY

Music generation using artificial intelligence (AI) for item listings is leveraged with an online marketplace. In one or more implementations, a user (e.g., a seller) of the online marketplace may post an item or product for sale. The corresponding item listing may include various information about the item, such as a name, a description, a price, and one or more images. In addition, the item may be associated with a category of the online marketplace. The item information may be input to an AI model, such as a large language model (LLM), which may be trained on a set of music data (e.g., music tones, notes, and notations) and a set of inventory categories of the online marketplace.

The LLM may execute with the item information as an input and generate a music sample that is pertinent to the listed item and would be appealing to the relevant audience (e.g., potential buyers of the item). If the generated music sample is too similar to elements of the music data, then the LLM may execute again until the LLM generates a music sample appropriate for the item. The music sample may be applied to the item listing, for example, as standalone audio or as background music of a video of the item listing. In some examples, if music was previously generated for a similar item listing, then the previously-generated music may be applied to new item listings without generating new music samples.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a flowchart for music generation for item listings in accordance with aspects of the present disclosure.

FIG. 3 depicts a procedure in an example implementation of music generation for item listings in accordance with the aspects of the present disclosure.

FIG. 4 illustrates an example of a system that includes an example computing device that is representative of one or more computing systems and/or devices that may implement the various techniques described herein.

### DETAILED DESCRIPTION

Music generation for item listings on an online marketplace is described. In accordance with the described techniques, items may be available (e.g., listed) for sale on an online marketplace. In one or more implementations, the online marketplace may be accessible by decentralized computing devices that correspond to “clients” of the online marketplace, e.g., users that have accounts with the online marketplace. Users of the online marketplace may have some control over which items they list with or purchase from the online marketplace. For example, the users may determine when to list or purchase items, and may do so from different locations via a website or mobile application for the online marketplace.

When a seller posts an item for sale, the seller may include information about the item such as a title, a description, and one or more images in the item listing. In some implementations, the item listing may include a video depicting the item for sale. For example, the user may upload a video demonstrating use of the item, or if the user posts images with the item listing but not a video, then an AI model may be used to compile the images into a short video (e.g., showing the images as if in a slide show). However, such videos often lack audio or music of any kind, and therefore may be unappealing to buyers and may not positively influence their purchasing decisions.

To address these limitations, a system for music generation for item listings is described. In one or more implementations, the described techniques describe an automated process for generating music samples to be played for items that are listed for sale on an online marketplace. Specifically, a user (e.g., a seller) may post an item or product for sale on the online marketplace. A corresponding item listing may include various information about the item, such as a name, a description, a price, and one or more images, among other information. In addition, the item (e.g., a necklace) may be associated with a category (e.g., jewelry) of the online marketplace.

The item information may be input to an AI model, such as an LLM, which may be trained on a set of music data (e.g., musical tones, notes, notations, etc.) and a set of inventory categories of the online marketplace (e.g., jewelry, technology, etc.). The model may generate a music sample that is pertinent to the listed item, and the music sample may be applied to the item listing when the item is posted for sale. For example, the music sample may be applied as standalone audio on that seller's page. Alternatively, if the item listing includes a video depicting or demonstrating use of the item, the music sample may be played in the background of the video. In some implementations, the generated music sample may be applied to the item listings on different platforms associated with the online marketplace, such as a search and explore page and social media platforms. In some examples, if the music sample is determined to be too similar to or derivative of the music data, then the model may generate additional music samples until a music sample is appropriately specific for the item. Alternatively, if a similar item was previously listed and music was previously generated for that similar item, then the previously-generated music may be applied to the present item listing without the model generating new music.

The described techniques may result in several improvements (e.g., improvements to technology or a technical field). For example, the improvements include faster processing and faster data retrieval as an LLM trained to generate music can generate the music much faster than a user could do so manually. Because the LLM is trained on music data in a textual format (instead of an audio format), and therefore may receive inputs and generate outputs in textual formats that can later be easily converted to audio formats, the described techniques also result in more efficient data usage and storage and reduced hardware requirements. Moreover, utilizing listing data of an item as training data and as an input for the LLM improves data storage and usage efficiency. The described techniques enhance graphical user interface (GUI) features by prompting users with a simple choice of whether or not to include generated music in item listings, rather than requiring the user to navigate through a complicated configuration process. The described techniques also result in improved efficiency and optimized data storage by applying previously-generated music samples to similar item listings instead of re-generating similar music samples each time a similar item is listed for sale.

Conventional systems may require advanced sciences to generate audio based on simple English inputs from users. Rather, the described technique employ a dynamic content-generation mechanism to create music from scratch. As the LLM is trained on music data and category data, the LLM automatically determines a theme or overall feeling of the music that is pertinent to the item, and as a result, users (e.g., buyers) may be more inclined to purchase the item when they hear the music. Specifically, the described LLM understands an item that is to be listed, synthesizes unique traits of the item to determine a theme, and dynamically generates a textual script which is used to generate sound using an AI infrastructure. These techniques result in improved efficiency, reduced data storage requirements, and faster processing compared to such conventional systems.

In some aspects, the techniques described herein relate to a computer-implemented method including: receiving information associated with an item listing for an online marketplace; generating a music sample based on executing an LLM with the information as an input, wherein the LLM is trained on a set of music data and a set of inventory categories associated with the online marketplace; and applying the music sample to the item listing.

In some aspects, the techniques described herein relate to a computer-implemented method further including retrieving, from a data store, a second music sample previously generated for a second item listing, wherein the item listing is similar to the second item listing; and applying the second music sample to the item listing based on the similarity.

In some aspects, the techniques described herein relate to a computer-implemented method further including comparing the music sample to the set of music data; and applying the music sample to the item listing based on a similarity between the music sample and the set of music data.

In some aspects, the techniques described herein relate to a computer-implemented method further including converting the music sample from a first format to a second format, wherein the music sample is applied to the item listing in the second format.

In some aspects, the techniques described herein relate to a computer-implemented method further including generating a video associated with an item in the item listing based on one or more images of the item included in the information; and applying the music sample over the video as part of the item listing.

In some aspects, the techniques described herein relate to a computer-implemented method, wherein the music sample is applied to the item listing based on an approval from a user.

In some aspects, the techniques described herein relate to a computer-implemented method further including identifying a subset of the set of music data associated with the item listing based on the information; and generating the music sample using the LLM based on the subset of the set of music data.

In some aspects, the techniques described herein relate to a computer-implemented method, wherein the set of music data includes at least one of musical notations, musical notes, or musical tones.

In some aspects, the techniques described herein relate to a computer-implemented method, wherein the music sample is related to an inventory category of an item in the item listing.

In some aspects, the techniques described herein relate to a system including:
one or more processors; and memory storing instructions that, when executed by the one or more processors, cause the system to: receive information associated with an item listing for an online marketplace; generate a music sample based on executing an LLM with the information as an input, wherein the LLM is trained on a set of music data and a set of inventory categories associated with the online marketplace; and apply the music sample to the item listing.

In some aspects, the techniques described herein relate to a system, wherein the instructions further cause the system to retrieve, from a data store, a second music sample previously generated for a second item listing, wherein the item listing is similar to the second item listing; and apply the second music sample to the item listing based on the similarity.

In some aspects, the techniques described herein relate to a system, wherein the instructions further cause the system to compare the music sample to the set of music data; and apply the music sample to the item listing based on a similarity between the music sample and the set of music data.

In some aspects, the techniques described herein relate to a system, wherein the instructions further cause the system to convert the music sample from a first format to a second format, wherein the music sample is applied to the item listing in the second format.

In some aspects, the techniques described herein relate to a system, wherein the instructions further cause the system to generate a video associated with an item in the item listing based on one or more images of the item included in the information; and apply the music sample over the video as part of the item listing.

In some aspects, the techniques described herein relate to a system, wherein the music sample is applied to the item listing based on an approval from a user.

In some aspects, the techniques described herein relate to a system, wherein the instructions further cause the system to identify a subset of the set of music data associated with the item listing based on the information; and generate the music sample using the LLM based on the subset of the set of music data.

In some aspects, the techniques described herein relate to a system, wherein the set of music data includes at least one of musical notations, musical notes, or musical tones.

In some aspects, the techniques described herein relate to a system, wherein the music sample is related to an inventory category of an item in the item listing.

In some aspects, the techniques described herein relate to a non-transitory computer-readable media storing instructions that, when executed by one or more processors, cause the one or more processors to: receive information associated with an item listing for an online marketplace; generate a music sample based on executing an LLM with the information as an input, wherein the LLM is trained on a set of music data and a set of inventory categories associated with the online marketplace; and apply the music sample to the item listing.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

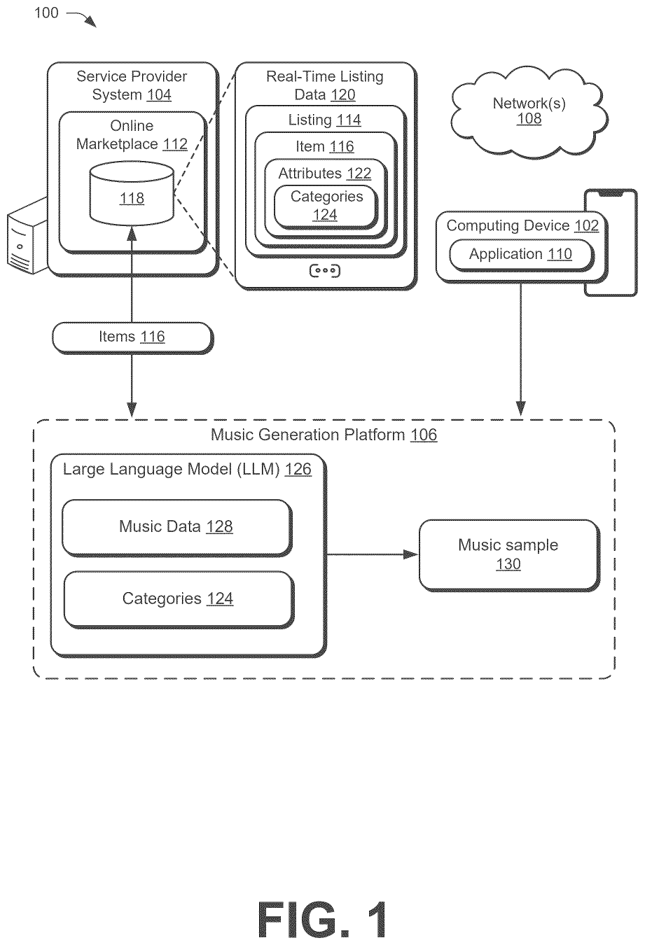

FIG. 1 is an illustration of an environment 100 in an example implementation that is operable to employ techniques described herein. The environment 100 includes a computing device 102, a service provider system 104, a music generation platform 106. In one or more implementations, the computing device 102, the service provider system 104, and the music generation platform 106 are communicatively coupled, one to another, via network(s) 108. One example of the network(s) 108 is the Internet, although one or more of the computing device 102, the service provider system 104, and the music generation platform 106 may be communicatively coupled using one or more different connections or different networks in various implementations (e.g., a cloud).

Although the music generation platform 106 is depicted in the environment 100 as being separate from the computing device 102 and the service provider system 104, in one or more implementations, an entirety or various portions of the music generation platform 106 are implemented at or by the computing device 102 and/or the service provider system 104. In at least one implementation, for example, at least a portion of the music generation platform 106 is implemented by an application 110 of the computing device 102 and/or using various resources of the computing device 102, such as hardware resources, an operating system, firmware, and so forth. Additionally, or alternatively, at least a portion of the music generation platform 106 is implemented by resources (e.g., server-based storage, processing, and so on) of the service provider system 104. Additionally, or alternatively, at least a portion of the music generation platform 106 is implemented using a third-party service, such as a web services platform that provides one or more hardware and/or other computing resources to support provision of services by web service providers.

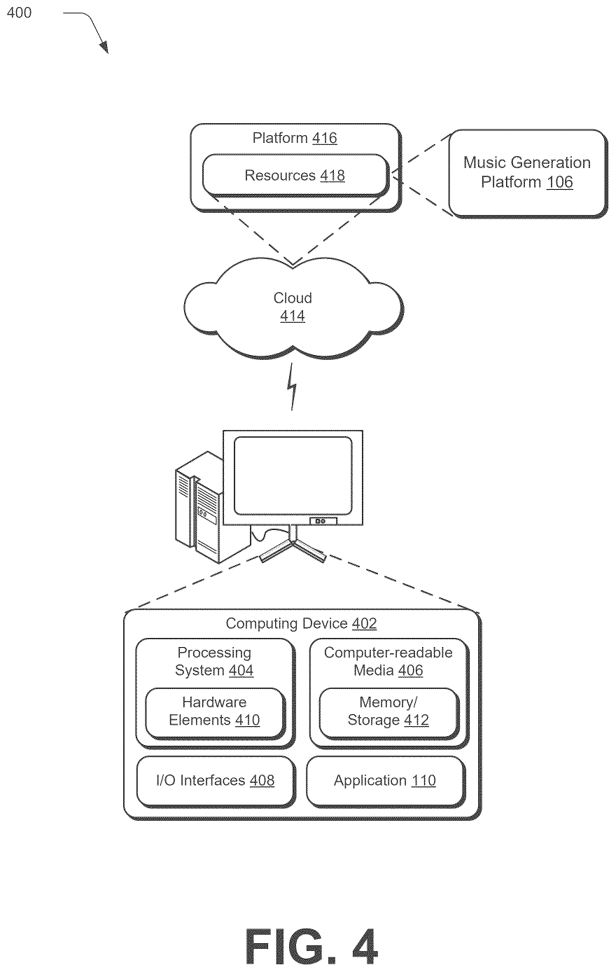

Computing devices that implement the environment 100 are configurable in a variety of ways. A computing device (e.g., computing device 102), for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 4.

In at least one implementation, the application 110 supports communication of data across the network(s) 108, such as between the computing device 102 and the service provider system 104 and/or between the computing device 102 and the music generation platform 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112 and/or music generation platform 106. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, facilitate user interaction with web pages of the online marketplace 112's website, and search for listings, items, and/or functionality of the online marketplace 112. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings 114 for items 116 and to expose those listings 114 (e.g., publish them) across the network(s) 108 to one or more computing devices, including to the computing device 102. For example, the online marketplace 112 may generate listings 114 for items 116 for sale and expose those listings to computing devices, such that users of the computing devices can interact with the listings via user interfaces to initiate transactions (e.g., purchases, add to wish lists, share, and so on) in relation to the respective item 116 or items 116 of the listings. In accordance with the described techniques, the items 116 include one or more types of physical goods or property (e.g., clothing and/or clothing accessories, jewelry, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes a storage device 118, which is depicted as maintaining real-time listing data 120. The real-time listing data 120 includes a plurality of listings 114 of the online marketplace 112. The storage device 118 may represent one or more databases and/or other types of storage capable of storing the real-time listing data 120. Examples of the storage device 118 include, but are not limited to, mass storage and virtual storage. In one or more implementations, for example, the storage device 118 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account. In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items 116 listed with the online marketplace 112 (e.g., the items 116 that those users decide to list through the online marketplace 112) than the company associated with the online marketplace 112 (or its employees or agents).

Users that cause items 116 to be listed on the online marketplace 112 may be referred to as “sellers,” whereas users that purchase or otherwise obtain items 116 listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items 116 to be listed on the online marketplace 112 and by interacting with the user interfaces to purchase one or more items 116 from the listings of the online marketplace 112.

A user that is a seller, for instance, may interact with one or more user interfaces of the online marketplace 112 (e.g., output via the application 110) to provide information about one or more items 116 which the user is causing to be listed on the online marketplace 112. Such user interfaces may include prompts that instruct, or guide, users that are sellers to provide various information about items 116 being listed. Examples of information that such interfaces prompt sellers for and that those users provide include, but are not limited to, a title, description (of the item 116), one or more prices (e.g., to purchase the item 116 now and/or a minimum starting bid for the item 116), brand information, size, year, color(s), shipping information (e.g., cost and/or types available), delivery information, return information, payment information, images, videos, models, authenticity information, item history (e.g., chain of custody), and condition (of the item 116), to name a few.

One or more portions of such information may be referred to herein as attributes 122 of the listing 114. For example, a title of the listing 114 may be an attribute 122 of the listing, a description of the item 116 being listed may be an attribute 122 of the listing 114, one or more images uploaded or selected for the listing 114 may be one or more attributes 122 of the listing 114, color(s) of the item 116 may be an attribute 122 of the listing 114, one or more categories 124 (e.g., product or item classes) of the item 116 may be attributes 122 of the listing 114, and so forth. The categories 124 may provide a way to organize inventory of the online marketplace.

In one or more implementations, the categories 124 of the online marketplace 112 include a category hierarchy (e.g., a tree structure) in which more specific child categories 124 (e.g., smartphones) fall under more generic parent categories 124, e.g., electronics. Additionally, or alternatively, the categories 124 of the online marketplace 112 include a plurality of sector categories 124 (e.g., sports) each including one or more highest-level or root categories 124 (e.g., sports memorabilia, sporting goods). Given this, the categories 124 associated with a listing 114 for an item 116 can include the categories 124 of the category hierarchy that the item 116 falls under (e.g., from the root category 124 to the lowest-level or leaf category 124), and one or more sector categories 124 to which the item 116 belongs.

In one or more implementations, the online marketplace 112 saves and maintains the input information for a listing 114 in the storage device 118 in fields of a data structure or data record populated for the listing 114, where a given field and the information populated and maintained for the given field correspond to a particular attribute 122 of the listing 114. For instance, a ‘title’ field of such a data structure or data record may be populated with information (e.g., text) input into a user interface by a seller of a listing 114. The title field and the information input by the user as the title of the listing 114 correspond to an attribute 122 of the listing 114, e.g., a title attribute. In one or more implementations, one or more of the attributes 122 of a listing 114 may be derived and then populated by the online marketplace 112, such as by the online marketplace 112 processing one or more portions of the information input by a user to populate one or more respective attributes of the listing 114.

In one or more implementations, the music generation platform 106 may support an LLM 126. The LLM 126 may be an example of a multi-modal model, which may be capable of processing different types of data (e.g., text, images, videos, audio) simultaneously, or other types of generative AI models. The LLM may be trained on music data 128 and categories 124. The music data 128 may include musical notations, music notes, music tones, and other musical elements. Musical notations include visual representations of data in the form of marks and symbols, such as sheet music, that may include musical notes and indications of musical tones. Musical notes include visual representations of distinct sounds (e.g., notes A, B, C, D, E, F, and G) in a musical notation, and music tones include the pitch, duration, intensity, timbre, and other qualities of a musical note. The music data 128 may be in a text format capable of conversion to an audio format, or the music data 128 may be in an audio format. The categories 124 may include all categories 124 within the category hierarchy of the online marketplace.

To generate a music sample 130 that is applicable to an item 116 or items 116, the LLM 126 may receive the real-time listing data 120 as an input. Any information related to the item 116, particularly a title, a description, and other attributes 122, may enable the LLM 126 to generate the music sample 130 such that the music sample is pertinent to the item 116 and appealing to a relevant audience (e.g., prospective buyers of the item 116). As the LLM 126 is trained on the music data 128 and the categories 124, the LLM 126 may generate a unique music sample with a theme or overall feeling that is relevant to the specific item 116. To generate the music sample 130, the LLM 126 may employ few-shot retrieval-augmented-generation (RAG) prompting to retrieve relevant data or examples from the music data 128 and the categories 124 and use that create a textual-music script.

The textual-music script may include new combinations of musical notes and tones based on the relevant data, and the textual-music script may be converted to an audio format to play the music sample 130 as a sound. By way of example, if the item 116 includes fine jewelry, then the music may be more melodious and grand compared to music for a VR headset or an electric printer, which may be more electronic. In this way, each category of items listed for sale on the online marketplace 112 may have a different appeal to buyers from a particular segment, and the music may reflect those differences.

In some implementations, the LLM 126 may generate the music sample 130 by comparing musical notes, musical tones, and musical notations of the music data 128 to a determined audience for the item 116 within the listing 114 to identify particular musical notes, musical tones, and musical notations that match the determined audience and the item 116. That is, the LLM 126 may determine a relevant audience for the item 116, which may include buyers who are likely to search for that item 116 (e.g., the relevant audience for automotive parts may include mechanics and car enthusiasts). Then, the LLM 126 may identify elements of the music data 128 that correspond to that particular audience. The elements may have been previously associated with that audience when generating other music samples for closely related items 116, or the LLM 126, or the LLM 126 may have access to some other data source that indicates that audience generally prefers a certain style or genre of music. The LLM 126 may then generate or select new musical elements (e.g., notes, tones, notations) to include in the music sample 130 that are based on the elements of the music data 128 that were identified as corresponding to the audience (e.g., the LLM 126 may generate rock music for this particular item and audience).

Additionally, or alternatively, the LLM 126 may generate the music sample 130 based on applying a chain-of-thought, sequential-claim LLM to a last k-viewed or watched items 116. The LLM may generate a characteristic mapping of known user personas (e.g., mechanics and car enthusiasts listen to rock music) to categories of items having a particular threshold (e.g., a purchase threshold, representing a number of times a type of item 116 has been purchased, or a watched-item threshold, representing a number of times photos or videos of an item 116 have been viewed or watched). Based on the persona and category of items of the characteristic mapping, the LLM 126 may apply few-shot RAG prompting to generate a textual-music script for that category of items that may be later converted to sound as the music sample 130.

The music sample 130 may be applied to the listing 114 when the listing 114 is posted for sale. For example, the music sample 130 may be applied to the listing 114 as standalone audio. Alternatively, if the listing 114 includes a video depicting or demonstrating use of the item 116, the music sample 130 may be played as background music for the video. In such cases, a video-generation system may generate a video associated with the item 116 based on one or more images of the item 116 included in the listing 114. The video may be a slideshow or other compilation of the images, for example, or the seller may upload their own video with the listing 114 (e.g., demonstrating how the item works or is used). The music sample 130 may be applied to such videos as background music such that the music sample 130 is incorporated in the listing 114. Alternatively, the music sample 130 may play on a seller's page (e.g., rather than for a specific video or listing 114). In some implementations, the music sample 130 may be applied to the listing 114 on different platforms associated with the online marketplace 112, such as a search and explore page and social media platforms.

In some examples, music samples 130 may be stored at the storage device 118 such that the music samples 130 may be reused for subsequent listing 114. If the subsequent listing 114 includes a similar item 116 to that in a previous listing 114, the LLM 126 may retrieve a music sample from the storage device 118 that was previously generated for the item 116 in the previous listing 114 and simply apply that same music sample to the subsequent listing 114 based on the items in the two listings being similar. In some implementations, music samples 130 may be stored at the storage device 118 in such a way that allows the LLM 126 to retrieve a music sample 130 for a similar listing 114. For example, the music samples 130 may be stored and organized at the storage device 118 based on an identifier corresponding to each item 116 or category of items (e.g., music samples 130 for smartphones or the electronics category may be stored with a first identifier, where music samples 130 stored for necklaces or the jewelry category may be stored with a second identifier). The LLM 126 may search the storage device 118 for music samples 130 with identifiers that match the identifier of the item in the subsequent listing 114 before generating new music. By way of example, if the music sample 130 is generated for an item 116 (e.g., a smartphone) and another user lists a similar item (e.g., a smartphone of the same model) later on, the music sample 130 generated for the item 116 may also be applied to the subsequent listing so that there is no need for the music generation platform 106 to regenerate similar music.

Having considered an example of an environment, consider now a discussion of some example details of the techniques for using an AI-based system for component compound identification in accordance with one or more implementations.

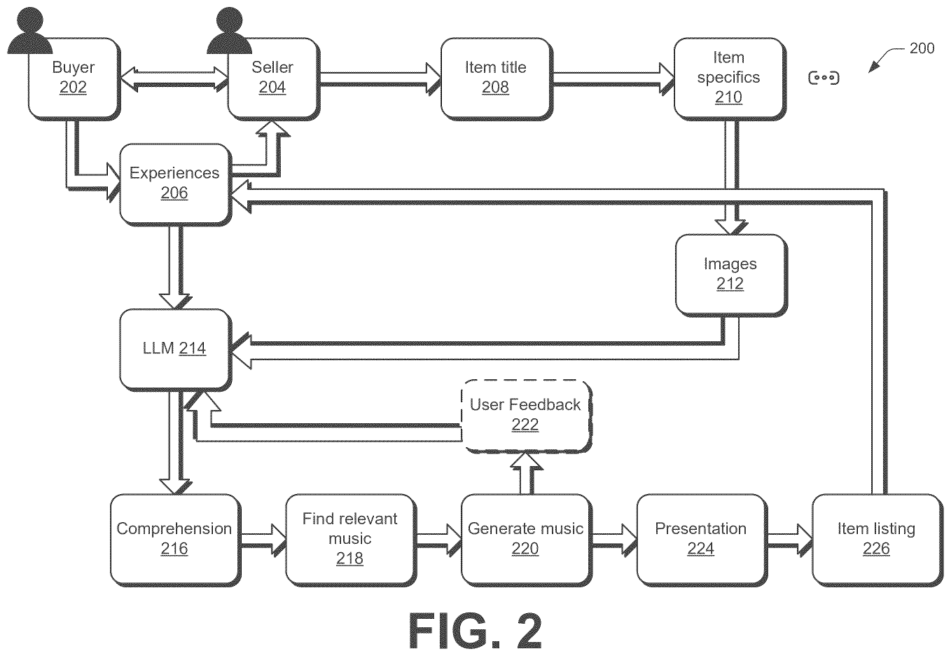

FIG. 2 depicts an example of a flowchart 200 for music generation for item listings in accordance with aspects of the present disclosure. The flowchart 200 may be implemented in or otherwise supported by the computing device 102, the service provider system 104, and the music generation platform 106, as described with reference to FIG. 1. For example, the flowchart 200 may be implemented for an online marketplace.

In the example of FIG. 2, users of the online marketplace, including a buyer 202 and a seller 204, may participate in experiences 206 on the online marketplace. The experiences 206 may include numerous and varied activities that facilitate transactions on the online marketplace, such as buying and selling items, listing items for sale, bidding on an item in an auction, and the like. For example, the seller 204 may list an item for sale by posting an item listing. In the item listing, the seller 204 may include an item title 208 and other item specifics 210 (e.g., information about the item), such as a description, a price, shipping information, and other information. After posting the item title 208 and any other item specifics 210, the seller 204 may attach images 212 of the item to the item listing.

The item title 208, the item specifics 210, the images 212, and any other item information included in the item listing may be provided to an LLM 214 as an input. As described herein, the LLM 214 may be trained on music data (e.g., musical notations, notes, and tones) and a set of inventory categories of the online marketplace (e.g., product or item classes). Based on the input and the training data, the LLM 214 may use graph knowledge for comprehension 216 of the item listing. To comprehend the item listing, the LLM 214 may leverage knowledge activation mechanisms using graphical connections between the types of sounds, types of inventory, and inventory categories, among other item information, to understand what type of music is most fitting for the specific item.

Based on the comprehension 216 of the item listing, the LLM 214 may determine what types of sounds may be aesthetically appealing for that category of inventory. For example, if the item listed in a jewelry category (e.g., necklaces, earrings, rings, etc.), the LLM 214 may determine that melodious (i.e., pleasant and tuneful) music may be appealing to the relevant buyer. If the item is of an electronics category (e.g., phones, gaming systems, televisions, etc.), the LLM 214 may determine that grand (i.e., loud, rich, resonant) music may be more appropriate and appealing to the relevant buyer (as compared to the melodious music described for the jewelry category). In some implementations, the LLM 214 may identify musical notations, notes, and tones from the music data that are common for items in the category (e.g., a common denominator) and create a soundscape that may be used to generally represent that item.

In some examples, the LLM 214 may identify a subset of the music data on which the LLM 214 is trained and generate the music 220 based on the subset. The LLM 214 may identify that a particular genre of music is relevant to an item listing based on precious associations the LLM 214 identified between music genres, categories of items, and relevant audiences, or the LLM 214 may identify a subset of the music data (including any one or more of musical notes, tones, and notations) that has an identifier corresponding to a particular category of items. In this way, the LLM 214 may narrow down the type or genre of the music 220 before generating it.

When the LLM 214 understands what style and overall sound of music should be applied to the item, the LLM 214 may attempt to find relevant music 218 such that the LLM 214 may generate music 220 (e.g., a new music sample) for the item listing. In some implementations, the online marketplace may cache metadata and one or more object storage identifiers (IDs) for the information included in any given item listing using a low-latency, key value system. In this way, when the seller 204 inputs the item title 208 for an item listing, the LLM 214 may identify that item based on the characters in the item title 208 and already begin triangulating on a specific class or type of music that would be relevant for that seller even before the seller 204 uploads the images 212. The relevant music 218 (e.g., the specific class of music) may include any combination of musical notations, tones, notes, beats, rhythms, and other musical elements.

In some implementations, the item being sold and the audience (e.g., perspective buyers 202) of that item may be determined in order to find the relevant music 218. Audience information may be derived by a chain-of-thought sequential-chain LLM, which may use a last k-viewed (or watched) items from the online marketplace to create a characteristic mapping of a buyer 202 to one of a known persona. Each persona may be mapped to categories (e.g., classes) of inventory that the persona has a propensity to purchase. Using the techniques described herein, the LLM 214 may generate a discrete set of sounds. The sounds may be judged as relevant to the persona or not by a human (e.g., a system administrator). Using deep learning and other AI techniques, the LLM 214 may identify common underpinnings to sounds in the relevant music 218 deemed to be relevant to the persona. Using a generative AI model, a textual representation of the sounds may be trans-mutated to identify similarities and dissimilarities between the generated sounds and existing music (e.g., used to train the LLM 214). The textual representation may be mapped to top-level categories of items (e.g., parent categories) of the online marketplace. Since the propensity model for the buyer 202 has items as the common underpinning, the textual representation of the music may be mapped to the top-level category of items to provide a personalized soundscape experience to the buyer 202.

Based on understanding the class of relevant music 218, the LLM 214 may generate the music 220 for the item. The music 220 may be based on the comprehension 216 of the item listing such that the music 220 is appealing in the context of that item and/or category. For example, using tones, notes, beats, and other musical elements from the relevant music 218, and based on the item title 208, the item specifics 210, and the images 212, the LLM 214 may use a dynamic content generation mechanism to generate the music 220 from scratch. That is, the LLM 214 may consider the item being listed and synthesize the unique traits of the item (e.g., included in the item specifics 210) to determine a theme for corresponding music. Based on the theme, the LLM 214 may generate a textual script (e.g., a text file) that may be later converted to an audio file to generate sound using an AI infrastructure. That is, the LLM 214 may generate the music 220 and notate the music 220 in a text format (e.g., a first format). The text format may be later converted into a wave or audio file (e.g., a second format) when the music 220 is played for a seller 204. In this way, each music sample of the music 220 generated and eventually posted on the online marketplace as part of an item listing has an audio file and a corresponding textual file.

In some implementations, the music 220 may be altered and modified by a user (e.g., a system administrator) once the music 220 has been generated based on user feedback 222. The user feedback 222 may be collected based on human-judgements or crowd-sourcing, which both may allow users (e.g., buyers 202, sellers 204, system administrators) to indicate their feelings or preference toward particular music. Such human judgements and crowd-sourcing may aid the LLM 214 in generating music that is both applicable to an item or category of items and appealing to the user. For example, the music 220 may be provided to a set of buyers 202 of the online marketplace, and A/B testing may be conducted to determine whether the music 220 influenced the buyers 202 to make a decision regarding whether or not to purchase the corresponding item. A system may measure gestures from a buyer 202 (e.g., clicking on a video of the item with the music 220 playing in the background, adding the item to a cart, and potentially buying the item) and use the gestures as proxy signals for asserting whether the music 220 actually influenced the buyer 202 to make a purchasing decision. Similar methods for gathering the user feedback 222, including other types of reinforcement learning through human feedback (RLHF) and direct preference optimization, may be used to continuously train the LLM 214 and improve the music 220 generated for a specific item.

Alternatively, to obtain user feedback 222 and improve the music 220, the music 220 may be provided to a set of users (e.g., system administrators) that may have experience in both music and consumer behavior. The users may provide the user feedback 222 regarding how the music 220 affected their behavior in the context of the item, and the music 220 may be modified manually or using the LLM 214 (e.g., iteratively) based on the user feedback 222. For example, the music 220 may be changed from a C major scale to a C minor scale, or from a pentatonic scale to a diatonic scale. These and other strategies for gathering user feedback 222 may be used to continuously improve the music 220.

In some examples, the LLM 214 may compare the music 220 to the set of music data on which the LLM 214 was trained, which may include existing music and music previously-generated by the LLM 214. Based on the similarity between the music 220 and the music data, the LLM 214 may apply the music 220 to the item listing. If the music 220 is too similar to existing music, then the LLM 214 may re-generate the music 220. For example, a high similarity score between the music 220 and some existing music may indicate that the LLM 214 simply generated a derivative of the existing music. In such cases, the LLM 214 may generate the music 220 again until the music 220 is more distinct or unique (e.g., below a threshold similarity score). If the music 220 is sufficiently distinct from the existing music (e.g., the similarity score between the music 220 and the existing music is low or below a threshold similarity score), then the LLM 214 may apply that music 220 to the listing as the music 220 was generated. In some examples, the LLM 214 may determine the similarity between the music 220 and the existing music based on at least one of respective musical notes, musical tones, or musical notations. For example, as music 220 generated for similar items and therefore, similar audiences, will inherently have some of the same elements, the LLM 214 may allow for some sameness in notes or melody. However, if a certain percentage of the music 220 is taken exactly from other music (whether generated by the LLM 214 or not), the LLM 214 may be required to make the music 220 more distinct.

In another example, as the number of musical notes are inherently limited, the music 220 will be allowed to share at least some musical notes with other music. Additionally, or alternatively, the LLM 214 may measure the similarity between the music 220 and the existing music in an audio format (e.g., based on how the two samples of music sound) or based on a textual format (e.g., how the musical notation for the music 220 compares to existing musical notations the LLM 214 was trained on).

In some examples, the LLM 214 may support a presentation 224 of the music 220 to a user (e.g., the seller 204), where the seller 204 may approve or deny the music 220 for their item listing. In some implementations, the seller 204 may approve the music 220 as standalone audio to play while a buyer 202 is viewing a specific item or all inventory on the seller 204's page. In some other implementations, the seller 204 may approve the music 220 as background music for a video displaying the item.

By way of example, the LLM 214 may generate one or more samples of music 220 for a given item as described herein. Using the images 212 to the item listing, a backend video generation system may begin creating one or more sample videos based on the images 212, where each sample video includes one of the samples of music 220 being played in the background. The sample videos may have the same music 220 or different music 220 based on what the LLM 214 generated, and the sample videos may display the images 212 with different effects (e.g., zooming in an out, switching between the images 212 with a slideshow effect, etc.). The seller 204 may be presented with the sample videos, which at this point have not actually been generated. If the seller 204 selects one of the sample videos and corresponding music to include in the item listing, the video generation system may initiate video generation (the corresponding music 220 has already been generated). In some examples, the video may also include contextually relevant text.

The item listing 226 may be posted on the online marketplace with the music 220 and in some cases, a video, if approved by the seller 204. Alternatively, the item listing 226 may be posted without the music 220 and/or the video if preferred by the seller 204. In some examples, the music 220 may be applied specifically to art and NFTs transacted on the online marketplace. The seller 204 remove the music 220 and/or the video from the item listing 226, or request that the music 220 and/or the video be changed, at any time. The item listing 226 may be involved in numerous experiences 206 between the buyer 202 and the seller 204, including the seller 204 posting the item listing 226 on the online marketplace, a buyer bidding on and/or purchasing an item in the item listing 226, and the like.

In some examples, the music 220 may be tailored to specific audiences. For example, if the item listing 226 is for rare coins, the LLM 214 may identify that people often associate luxury and history with these types of items. Accordingly, the LLM 214 may generate instrumental flute music to play with this listing (e.g., in the background of a video or a live auction), which may influence a buyer 202 in a positive direction toward purchasing that item. However, other buyers 202 may associate rare coins with hard rock music. The LLM 214 may also identify this audience, and generate hard rock music to play with the listing. In this way, the LLM 214 may customize the music 220 for specific buyers 202.

In some other examples, the LLM 214 may generate music 220 for customer support interactions. For example, the LLM 214 may generate calming music to be played while a customer is on call with a customer support agent to reduce frustration.

In some other examples, the LLM 214 may generate music 220 to be played while the seller 204 is waiting for the online marketplace to process their item listings. For example, the online marketplace may support operations such as AI-generated descriptions (for the item specifics 210) and background removal on images 212. The music 220 may be played in the time it takes these operations to be completed to encourage the seller 204 to continue instead of abandoning the posting.

Additionally, or alternatively, the music 220 generated by the LLM 214 may be applied to live video demonstrations and live auctions, for example, as transition audio between items being sold. The music 220 may also be played on a search-results page for “top-rated-seller” items as a value-add for the seller 204, and on a storefront of a seller 204 that would like to select and curate a specific soundscape, among other applications.

Having discussed exemplary details of an AI-based system for component compound identification, consider now some examples of procedures to illustrate additional aspects of the techniques.

This section describes examples of procedures for an AI-based smart actioning system. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

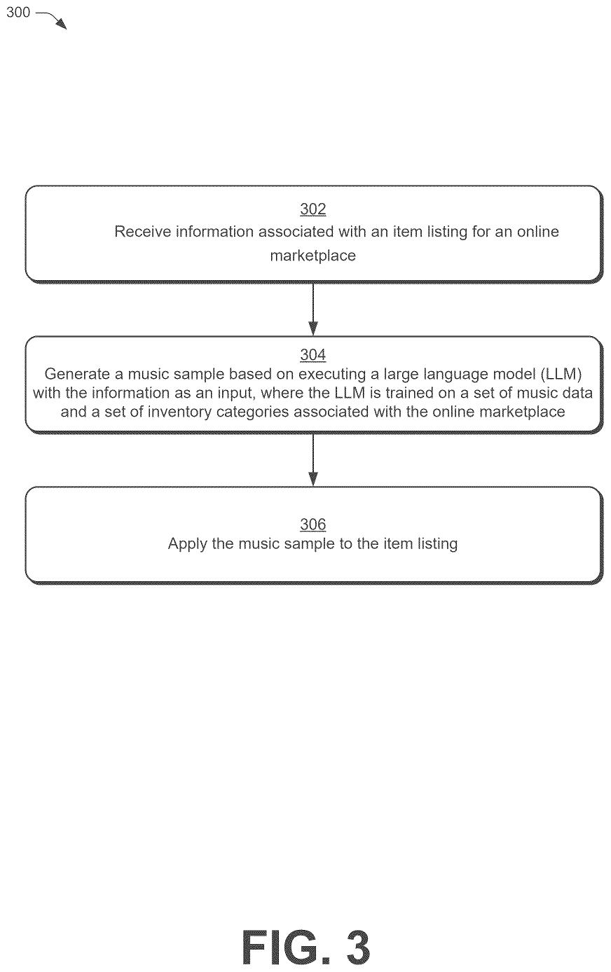

FIG. 3 depicts a procedure 300 in an example implementation of music generation for item listings on an online marketplace.

Information associated with an item listing for an online marketplace is received (block 302). By way of example, a user (e.g., seller) may post a listing 114 of an item 116 for sale on the online marketplace 112. The listing 114 may include information about the item 116, including a title, a description, one or more images, and other attributes. In addition, the item 116 may be associated with a category 124 (e.g., a specific product or item class).

A music sample is generated based on executing an LLM with the information as an input, where the LLM is trained on a set of music data and a set of inventory categories associated with the online marketplace (block 304). By way of example, the LLM 126 may receive the real-time listing data 120 (e.g., the information) as the input, where the LLM 126 may be trained on the music data 128 and the categories 124. Based on the input and training data provided, the LLM 126 may understand what types of sounds are aesthetically appealing for the item 116 and generate a music sample accordingly.

The music sample is applied to the item listing (block 306). By way of example, the music sample 130 may applied to the listing 114 as standalone audio or in the background of a video that depicts or demonstrates use of the item 116. In some examples, the same music sample may be applied to other listings 114 that include similar items 116.

Having described examples of procedures in accordance with one or more implementations, consider now an example of a system and device that can be utilized to implement the various techniques described herein.

FIG. 4 illustrates an example of a system 400 generally that includes an example of a computing device 402 that is representative of one or more computing systems and/or devices that may implement the various techniques described herein. This is illustrated through inclusion of the application 110 and the music generation platform 106. The computing device 402 may be, for example, a server of a service provider, a device associated with a client (e.g., a client device), an on-chip system, and/or any other suitable computing device or computing system.

The example computing device 402 as illustrated includes a processing system 404, one or more computer-readable media 406, and one or more I/O interfaces 408 that are communicatively coupled, one to another. Although not shown, the computing device 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware elements 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 406 is illustrated as including memory/storage 412. The memory/storage 412 represents memory/storage capacity associated with one or more computer-readable media. The memory/storage 412 may include volatile media (such as random access memory (RAM)) and/or nonvolatile media (such as read only memory (ROM), Flash memory, optical disks, magnetic disks, and so forth). The memory/storage 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Input/output interface(s) 408 are representative of functionality to allow a user to enter commands and information to computing device 402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 410 and computer-readable media 406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 410. The computing device 402 may be configured to implement particular instructions and/or functions corresponding to the software and/or hardware modules. Accordingly, implementation of a module that is executable by the computing device 402 as software may be achieved at least partially in hardware, e.g., through use of computer-readable storage media and/or hardware elements 410 of the processing system 404. The instructions and/or functions may be executable/operable by one or more articles of manufacture (for example, one or more computing devices 402 and/or processing systems 404) to implement techniques, modules, and examples described herein.

The techniques described herein may be supported by various configurations of the computing device 402 and are not limited to the specific examples of the techniques described herein. This functionality may also be implemented all or in part through use of a distributed system, such as over a “cloud” 414 via a platform 416 as described below.

The cloud 414 includes and/or is representative of a platform 416 for resources 418. The platform 416 abstracts underlying functionality of hardware (e.g., servers) and software resources of the cloud 414. The resources 418 may include applications and/or data that can be utilized while computer processing is executed on servers that are remote from the computing device 402. Resources 418 can also include services provided over the Internet and/or through a subscriber network, such as a cellular or Wi-Fi network.

The platform 416 may abstract resources and functions to connect the computing device 402 with other computing devices. The platform 416 may also serve to abstract scaling of resources to provide a corresponding level of scale to encountered demand for the resources 418 that are implemented via the platform 416. Accordingly, in an interconnected device embodiment, implementation of functionality described herein may be distributed throughout the system 400. For example, the functionality may be implemented in part on the computing device 402 as well as via the platform 416 that abstracts the functionality of the cloud 414.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving information associated with an item listing for an online marketplace;
generating a music sample based on executing a large language model (LLM) with the information as an input, wherein the LLM is trained on a set of music data and a set of inventory categories associated with the online marketplace; and
applying the music sample to the item listing.

2. The computer-implemented method of claim 1, further comprising:
retrieving, from a data store, a second music sample previously generated for a second item listing, wherein the item listing is similar to the second item listing; and
applying the second music sample to the item listing based on the similarity.

3. The computer-implemented method of claim 1, further comprising:
comparing the music sample to the set of music data; and
applying the music sample to the item listing based on a similarity between the music sample and the set of music data.

4. The computer-implemented method of claim 1, further comprising:
converting the music sample from a first format to a second format, wherein the music sample is applied to the item listing in the second format.

5. The computer-implemented method of claim 1, further comprising:
generating a video associated with an item in the item listing based on one or more images of the item included in the information; and
applying the music sample over the video as part of the item listing.

6. The computer-implemented method of claim 1, wherein the music sample is applied to the item listing based on an approval from a user.

7. The computer-implemented method of claim 1, further comprising:
identifying a subset of the set of music data associated with the item listing based on the information; and
generating the music sample using the LLM based on the subset of the set of music data.

8. The computer-implemented method of claim 1, wherein the set of music data includes at least one of musical notations, musical notes, or musical tones.

9. The computer-implemented method of claim 1, wherein the music sample is related to an inventory category of an item in the item listing.

10. A system, comprising:
one or more processors; and
memory storing instructions that, when executed by the one or more processors, cause the system to:
receive information associated with an item listing for an online marketplace;
generate a music sample based on executing a large language model (LLM) with the information as an input, wherein the LLM is trained on a set of music data and a set of inventory categories associated with the online marketplace; and
apply the music sample to the item listing.

11. The system of claim 10, wherein the instructions further cause the system to:
retrieve, from a data store, a second music sample previously generated for a second item listing, wherein the item listing is similar to the second item listing; and
apply the second music sample to the item listing based on the similarity.

12. The system of claim 10, wherein the instructions further cause the system to:
compare the music sample to the set of music data; and
apply the music sample to the item listing based on a similarity between the music sample and the set of music data.

13. The system of claim 10, wherein the instructions further cause the system to:
convert the music sample from a first format to a second format, wherein the music sample is applied to the item listing in the second format.

14. The system of claim 10, wherein the instructions further cause the system to:
generate a video associated with an item in the item listing based on one or more images of the item included in the information; and
apply the music sample over the video as part of the item listing.

15. The system of claim 10, wherein the music sample is applied to the item listing based on an approval from a user.

16. The system of claim 10, wherein the instructions further cause the system to:
identify a subset of the set of music data associated with the item listing based on the information; and
generate the music sample using the LLM based on the subset of the set of music data.

17. The system of claim 10, wherein the set of music data includes at least one of musical notations, musical notes, or musical tones.

18. The system of claim 10, wherein the music sample is related to an inventory category of an item in the item listing.

19. A non-transitory computer-readable media storing instructions that, when executed by one or more processors, cause the one or more processors to:
receive information associated with an item listing for an online marketplace;
generate a music sample based on executing a large language model (LLM) with the information as an input, wherein the LLM is trained on a set of music data and a set of inventory categories associated with the online marketplace; and
apply the music sample to the item listing.

20. The non-transitory computer-readable media of claim 19, wherein the instructions further cause the one or more processors to:
receive, from a data store, a second music sample previously generated for a second item listing, wherein the item listing is similar to the second item listing; and
apply the second music sample to the item listing based on the similarity.
